(19) United States
(12) Patent Application Publication
(10) Pub. No.: US 2021/0078684 A1
(43) Pub. Date: Mar. 18, 2021

(54) ABOVE-LIQUID REFRACTION-CORRECTING BUOYANT LENS DEVICE

(71) Applicant: Timothy A. LePage, Panama City, FL (US)

(72) Inventor: Timothy A. LePage, Panama City, FL (US)

(21) Appl. No.: 16/570,312

(22) Filed: Sep. 13, 2019

(51) Int. Cl. B63C 11/49; G02B 27/02; G02B 1/04; F21L 4/08

(52) U.S. Cl. CPC B63C 11/49; G02B 27/027; F21Y 2115/10; F21L 4/08; G02B 1/041

(57) ABSTRACT

An above-liquid refraction-correcting buoyant lens device is described. The above-liquid refraction-correcting buoyant lens device includes a viewing portion and a buoyant portion. The viewing portion includes optically transparent material. The buoyant portion can be disposed around an outer edge surface of the viewing portion. In some embodiments, the viewing portion has a viewing area of at least twenty-five square inches. In some embodiments, the viewing portion includes a magnification lens.

### BACKGROUND

Often, people will not even get into a body of water, such as a lake or an ocean, unless they can clearly see what is in the body of water. Furthermore, some bodies of water are very polluted, increasing the risk that someone will sustain an injury from stepping on debris (e.g., stepping on a piece of glass from a broken bottle) or stepping into chemically polluted bodies of water. Others are afraid of animals that may live in the bodies of water and therefore will not enter the body of water.

Furthermore, some people may not be able to use conventional water goggles, which are useful for seeing underwater. There are various reasons people may not be able or wish to use water goggles, such as the fear of putting their head under the water or breathing problems. Other people may also wish to see to the bottom of a body of water, but do not have the ability to dive. Therefore, there exists a need to provide a clear view below the surface of a body of water.

### BRIEF SUMMARY

An above-liquid refraction-correcting buoyant lens device is described. “Above-liquid” refers to the surface positioning of the lens for use of the device (as opposed to viewing through the device from below the surface). “Refraction-correcting” refers to the change in the value of the refraction index seen through an eye of the user caused by optically transparent material that is between a user and directly contacting the liquid the user intends to see (as opposed to the value of the refraction index a user would normally see by looking into the liquid directly). It should be understood that while this application discusses the device as being used in a body of water, the device may be used to view below the surface of any liquid to reduce distortions when attempting to view into that liquid from above the liquid.

The above-liquid refraction-correcting buoyant lens device includes a viewing portion and a buoyant portion. The viewing portion includes optically transparent material. The buoyant portion can be disposed around an outer edge surface of the viewing portion. In some embodiments, the viewing portion has a viewing area of at least twenty-five square inches. In some embodiments, the viewing portion includes a magnification lens.

### BRIEF DESCRIPTION OF THE DRAWINGS

FIG. 1A is a top view of an above-liquid refraction-correcting buoyant lens device.

FIG. 1B is a bottom view of an above-liquid refraction-correcting buoyant lens device.

### DETAILED DISCLOSURE

An above-liquid refraction-correcting buoyant lens device is described. The above-liquid refraction-correcting buoyant lens device includes a viewing portion and a buoyant portion. The viewing portion includes optically transparent material. The buoyant portion can be disposed around an outer edge surface of the viewing portion.

The device allows a user to see clearly through a body of water. For instance, a user may place the device on top of the body of water. The buoyant portion is buoyant, thereby keeping the device afloat. It should be understood that the “buoyant portion” includes material that, by itself, may or may not be buoyant but can be inflated to become buoyant or more buoyant than the material was originally. The viewing portion is made of an optically transparent material, thereby removing distortions caused by the movement of the water, wind, light reflection, and the like that normally prohibit a user from clearly seeing through the water.

The device is useful to those who want to see through the water for any reason, such as to see the bottom surface holding the body of water, so the person does not step on something the person does not wish to step on; to see plant and animal life (e.g., fish) in a lake, ocean, river, pond, and the like; and to generally explore the body of water. The device is also useful for those who wish to explore the body of water without having to put their head under the water (e.g., wearing swimming goggles in a pool). This can be useful for those who may not be able to hold their breath or have some other aversion to submersing their head in a liquid.

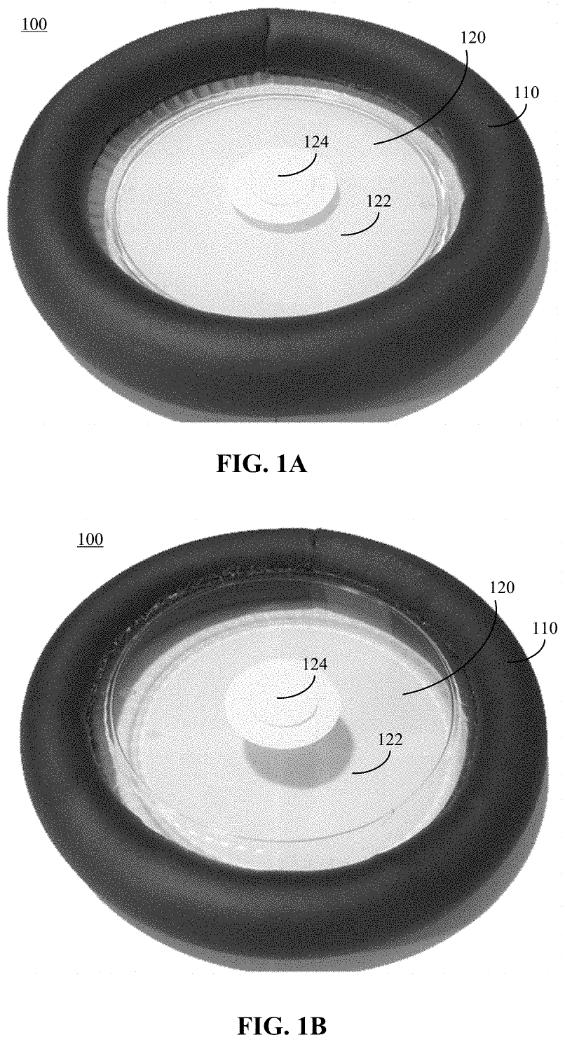

FIG. 1A is a top view of an above-liquid refraction-correcting buoyant lens device. FIG. 1B is a bottom view of the device. As illustrated in FIGS. 1A and 1B, the device 100 includes a buoyant portion 110 and an viewing portion 120. The viewing portion 120 includes optically transparent material 122. For example, the optically transparent material 122 may be made of poly(methyl methacrylate) (i.e., plexiglass or transparent acrylic), glass, polyethylene, and other amorphous polymers (i.e., plastics), and the like. In some cases, the optically transparent material 122 is scratch resistant. In some cases, the optically transparent material 122 may be colored (i.e., tinted a certain color). In these cases, the color of the optically transparent material 122 may be any color that is capable of being optically transparent, such as blue, purple, yellow, green, gray, orange, red, and the like.

The optically transparent material 122 may also include a minimum surface area. It should be understood that the minimum surface area that is discussed is for each side of the optically transparent material 122; in other words, when discussing the minimum surface area requirement, the numbers discussed are for a single side of the optically transparent material 122. Therefore, for a minimum surface area of 25 square inches, each side of the optically transparent material 122 must be a minimum of 25 square inches (obviously not including the edges of the optically transparent material 122).

In some cases, the minimum surface area of the optically transparent material 122 is 25 square inches. In some cases, the minimum surface area of the optically transparent material 122 is 27 square inches. In some cases, the minimum surface area of the optically transparent material 122 is 30 square inches. In some cases, the minimum surface area of the optically transparent material 122 is 50 square inches. In some cases, the minimum surface area of the optically transparent material 122 is 75 square inches. In some cases, the minimum surface area of the optically transparent material 122 is 100 square inches. In some cases, the minimum surface area of the optically transparent material 122 is 150 square inches. In some cases, the minimum surface area of the optically transparent material 122 is 200 square inches.

The viewing portion 120 may also include a magnifying lens 124 so that a user of the device 100 may see further into a body of water than is possible with normal optically transparent materials. It should be understood that the magnifying lens 124 may be made of the same type of materials (e.g., acrylic or glass) that the optically transparent material 122 of the viewing portion 120 is made of. In some cases, the magnifying lens is scratch resistant. In some cases, the magnifying lens 124 includes more than one (e.g., two, three, four, or five) different lenses so that varying levels of magnification may be achieved based on the user's desired magnification level. In some cases, the user is able to adjust the magnification of the magnification lens 124 so that the magnification lens 124 may function as a microscope to enhance magnification levels based on the user's desire. In some cases, the number of magnifying lenses (and thus the magnification level) used in the magnification lens 124 is fixed during manufacturing of the device 100.

In some cases, the device 100 can further include a leash attached to the buoyant portion 110. The leash may be similar to that found on surf boards and/or body boards. For example, a string/rope like material may be formed into the buoyant portion 110, with the string/rope like material extending several feet with a strap/fastener (e.g., a hook-and-loop fastener) attached to the other end. The strap/fastener may be designed to attach to a person's wrist, arm, leg, and/or ankle.

The shape of the device 100 may also vary. As can be seen in FIGS. 1A and 1B, the device 100 is disc-shaped, however, in some cases, other shapes may be used. For instance, the shape of the device 100 may be triangular, square, rectangular, pentagonal, hexagonal, and the like. The shape of the device 100 may also be an unconventional shape (e.g., a modified-V shape similar to the hull of a boat). In some cases, the shape of the buoyant portion 110 may be different than the shape of the viewing portion 120. For instance, the buoyant portion 110 may be disc-shaped and the viewing portion 120 may be square. In any case, the buoyant portion 110 substantially surrounds the viewing portion 120. It should be understood that “substantially surrounds” means that the buoyant portion 110 surrounds anywhere from the entire perimeter of the viewing portion 120 to greater than 50% of the perimeter of the viewing portion 120. As can be seen in FIGS. 1A and 1B, the buoyant portion 110 is formed around the entire perimeter of the viewing portion 120.

In some cases, the buoyant portion 110 includes a bladder that holds a liquid. For example, a bladder that is capable of holding a liquid may be contained within the buoyant portion 110. This may be useful to a user who wishes to carry drinkable liquid (e.g., a soda) into the body of water (e.g., the ocean) while using the device 100. In some cases, a spigot may provide a pathway for the liquid inside the bladder of the buoyant portion 110 to be evacuated. In some cases, a valve may be included (in alternative to or in conjunction with the spigot) for easy adding and removing of the drinkable liquid to the bladder of the buoyant portion 110. In some cases, the volume of drinkable liquid is replaced by air (and thereby causes an increase in buoyancy of the buoyant portion 110) as the drinkable liquid is evacuated from the buoyant portion 110. In some cases, the device 100 also includes a cupholder(s) formed in the buoyant portion 110. The buoyant portion 110 may also include handles for easy maneuvering of the device 100 in the body of water.

In some cases, the device 100 further includes a lighting unit. The lighting unit is capable of providing light (e.g., when the body of water the device is in is dark). The lighting unit may be attached to the buoyant portion 110 of the device 100. The lighting unit may include a solar cell, a battery, and a light emitting diode. The solar cell may be capable of providing a charge to the battery and/or directly provide power to the light emitting diode. For instance, the light emitting diode may detect when light from the sun is being provided and a circuit may direct the energy produced by the solar cell to the light emitting diode and direct any excess energy (that is not needed to provide power to the light emitting diode) to the battery. In some cases, the light emitting diode detects when light from the sun is being provided and a circuit may direct the energy produced by the solar cell to the battery. In some cases, the light emitting diode detects when light from the sun is not being provided and a circuit may direct the battery to provide power to the light emitting diode. In some cases, a switch is used to turn the light emitting diode on and off. In these cases, the solar cell may provide a charge to the battery when the switch is off and provide power to the light emitting diode and/or the battery when the switch is on, depending on whether the light emitting diode detects light from the sun and whether any excess energy is produced by the solar cell. In some cases, the lighting unit does not include a solar cell, such that the battery must be replaced or charged remotely from the device 100 when the charge in the battery drops below an effective level to provide power to the light emitting diode.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A water lens device, comprising:
a viewing portion having at least a surface area of at least twenty-five square inches that is made of optically transparent material; and
a buoyant portion comprising a buoyant material;
wherein the buoyant portion substantially surrounds and is attached to the viewing portion.

2. The lens of claim 1, wherein the viewing portion further includes a magnification lens.

3. The lens of claim 2, wherein the magnification level of the magnification lens is adjustable.

4. The lens of claim 1, wherein the optically transparent material is plexiglass.

5. The lens of claim 1, wherein the optically transparent material is made of polyethylene.

6. The lens of claim 1, wherein the buoyant portion further comprises a bladder capable of holding a fluid.

7. The lens of claim 1, wherein the optically transparent material is colored.

8. The lens of claim 1, further comprising a leash attached to the buoyant portion.

9. The lens of claim 1, further comprising a lighting unit.

10. The lens of claim 9, wherein the lighting unit comprises a solar cell, battery, and a light emitting diode, wherein the solar cell provides a charge to the battery and the battery and/or the solar cell provides power to the light emitting diode.

11. A water lens device, comprising:
a viewing portion comprising a magnification lens and optically transparent material;
a buoyant portion made of buoyant material;
wherein the buoyant portion substantially surrounds and is attached to the viewing portion.

12. The lens of claim 11, wherein the magnification level of the magnification lens is adjustable.

13. The lens of claim 11, wherein the optically transparent material has a surface area of at least twenty-five square inches.

14. The lens of claim 11, wherein the optically transparent material is made of plexiglass.

15. The lens of claim 11, wherein the optically transparent material is made of polyethylene.

16. The lens of claim 11, wherein the buoyant portion further comprises a bladder capable of holding a fluid.

17. The lens of claim 11, wherein the optically transparent material is colored.

18. The lens of claim 11, further comprising a leash attached to the buoyant portion.

19. The lens of claim 11, further comprising a lighting unit.

20. The lens of claim 19, wherein the lighting unit comprises a solar cell, battery, and a light emitting diode, wherein the solar cell provides a charge to the battery and the battery and/or the solar cell provides power to the light emitting diode.
